(19) United States
(12) Patent Application Publication
(10) Pub. No.: US 2013/0271394 A1
(43) Pub. Date: Oct. 17, 2013

(54) TOUCH PANEL

(71) Applicant: TERA XTAL TECHNOLOGY CO., LTD., HSINCHU CITY (TW)

(72) Inventor: JUN-WEN CHUNG, TAINAN CITY (TW)

(73) Assignee: TERA XTAL TECHNOLOGY CO., LTD., HSINCHU CITY (TW)

(21) Appl. No.: 13/667,065

(22) Filed: Nov. 2, 2012

(30) Foreign Application Priority Data
Apr. 17, 2012 (TW) 101113579

(51) Int. Cl. G06F 3/147

(52) U.S. Cl. CPC G06F 3/147
USPC 345/173

(57) ABSTRACT

A touch panel is revealed. The touch panel includes a substrate, a touch display module and a cover plate. The touch display module is clipped between the substrate and the cover plate to reduce the thickness of the touch panel. The cover plate or the substrate is made from matrix with Mohs hardness greater than 8 to have good surface hardness. Thus no coating or anti-smudge treatment on the surface of the cover plate or the substrate is required and the surface is durable to long term or multiple times of pressing and touching. The cover plate or the substrate will not have scratches, damages or smudges after long term or multiple times of use. The manufacturing cost is also reduced significantly.

### BACKGROUND OF THE INVENTION

1. Fields of the Invention

The present invention relates to a touch panel, especially to a touch panel made from matrix whose Mohs hardness is greater than 8.

2. Descriptions of Related Art

In the 1970s, the US military for the first time touch panel technology for military purposes and then the technology gradually is applied to civilian transfer such as automatic teller machines (ATM) in banks, automatic ticket vending machines in stations, store point of sale (POS) system, smart phones, vehicle touch panel, etc. Due to easy operation, the touch panel has replaced conventional keyboard to be used in various electronic products, especially mobile communication products and consumer products. The touch panel formed by a display panel and an input device has become essential component of high-level electronic products.

According to the type of sensor, touch panels are roughly divided into capacitive type, resistive type, surface acoustic wave type, infra-red type, etc. The resistive touch panel becomes a mainstream and maintains about 58% market share. The capacitive is the second largest, about 22%. The rest has small market share. Although the resistive touch panel has disadvantages of poor light transmittance, bad durability, etc, it still has become main stream on the market due to low cost and thinner thickness, and thus being applied to large amount of medium/small size consumer and communication electronic products. As to the capacitive touch panel, it can only perform single-touch compared to the resistive type. Although the capacitive type is more expensive, it's more durable, anti-scratch, not afraid of dust and dirt effects, and having multi-touch. Moreover, the image of the capacitive type can be enlarged or dragged easily and the operation is more user-friendly and instinctive. Furthermore, due to broader applications of multi-touch technology and patent expiration of the capacitive touch panels in near future, many companies have invested a lot in the development of the capacitive touch panels.

Along with the prevalence of glass touch panels, the glass has broader applications on portable devices. Generally, the glass can be coated with a conductive layer so that the glass needs to have high light transmittance. Or the glass is used as a part of the portable device for protecting the screen and the touch panel and the glass needs to have smudge resistance, dirt resistance, scratch resistance, impact resistance and enhanced structure. In order to prevent scratches or other damages on the surface of the touch panel, a cover plate (tempered glass) is arranged over the surface of the conventional touch panel. Thus there are three layers of substrates in the conventional touch panel and the thickness of the touch panel is increased. Moreover, the surface of the cover plate needs coating treatment and anti-smudge treatment to prevent smudges and dirt. Thus the manufacturing cost of the touch panel is increased.

In order to solve the above problems, a touch panel of the present invention reduces the thickness thereof dramatically by only a touch display module mounted between a substrate and a cover plate. Moreover, the cover plate or the substrate is made from matrix whose Mohs hardness is greater than 8 such as sapphire or spinel so that the cover plate or the substrate has good surface hardness. Without additional coating and anti-smudge treatment of the cover plate or the substrate, the manufacturing cost of the touch panel is reduced significantly.

### SUMMARY OF THE INVENTION

Therefore it is a primary object of the present invention to provide a touch panel that is formed by only a touch display module clipped between a substrate and a cover plate. Thus the thickness of the touch panel is reduced significantly.

It is another object of the present invention to provide a touch panel that includes a cover plate or a substrate made from matrix whose Mohs hardness is greater than 8. The cover plate or the substrate is with good surface hardness so that a surface of the cover plate or of the substrate is not necessary to have coating treatment. The cover plate or the substrate will not have scratches or stains even after long term use or multiple times of touching and the manufacturing cost of the touch panel is also reduced without additional treatment.

In order to achieve the above objects, a touch panel of the present invention includes a substrate, a touch display module disposed on the substrate and a cover plate that covers the touch display module. The Mohs hardness of the substrate, the Mohs hardness of the cover plate, or the Mohs hardness of both the substrate and the cover plate is greater than 8.

Another touch panel of the present invention includes a substrate, a display module arranged at the substrate, a cover plate covering the display module, and a touch sensor module disposed over the substrate and located between the cover plate and the display module. The Mohs hardness of the cover plate is larger than 8.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a schematic drawing showing structure of an embodiment of a touch panel according to the present invention;

FIG. 2 is a schematic drawing showing structure of another embodiment of a touch panel according to the present invention;

FIG. 3 is a schematic drawing showing structure of a further embodiment of a touch panel according to the present invention;

FIG. 4A is a perspective view of a 3-dimensional pattern layer of a further embodiment according to the present invention;

FIG. 4B is a cross sectional view of a 3-dimensional pattern layer of a further embodiment according to the present invention;

FIG. 5A is a perspective view of a 3-dimensional pattern layer of a further embodiment according to the present invention;

FIG. 5B is a cross sectional view of a 3-dimensional pattern layer of a further embodiment according to the present invention;

FIG. 6 is a cross sectional view of a 3-dimensional pattern layer of a further embodiment according to the present invention;

FIG. 7 is a cross sectional view of a further embodiment of a touch panel according to the present invention;

FIG. 8 is a cross sectional view of a further embodiment of a touch panel according to the present invention;

FIG. 9 is a cross sectional view of a further embodiment of a touch panel according to the present invention.

### DETAILED DESCRIPTION OF THE PREFERRED EMBODIMENT

In order to prevent scratches or other damages formed on the surface of the touch panel, a cover plate is disposed on the surface of the conventional touch panel. Thus the conventional touch panel has three layers of substrate and this increases the thickness of the touch panel. The cover plate is made from tempered glass whose Mohs hardness is ranging from 5 to 6 and is located on the outermost layer of the touch panel. Thus the cover plate is at the position being pressed and touched the most often by users. After being used for a long period or multiple times, the cover plate is easy to have dirt or stains. Thus the surface of the cover plate needs to have coating and anti-smudge treatment so as to increase stain resistance of the surface of the cover plate. This leads to a higher manufacturing cost.

In order to solve the above problem, a touch panel of the present invention only includes a touch display module arranged between a substrate and a cover plate for reducing the thickness of the touch panel. Moreover, the cover plate or the substrate on the outermost of the touch panel for users to touch and operate is made from matrix whose Mohs hardness is over 8 such as sapphire or spinel so that the cover plate or the substrate has good surface hardness. Thus there is no need to have coating and anti-smudge treatment on the surface of the cover plate or the substrate. Therefore the manufacturing cost is reduced significantly. Moreover, the surface of the cover plate or the surface of the substrate can be patterned so as to increase light transmittance of the cover plate or the substrate.

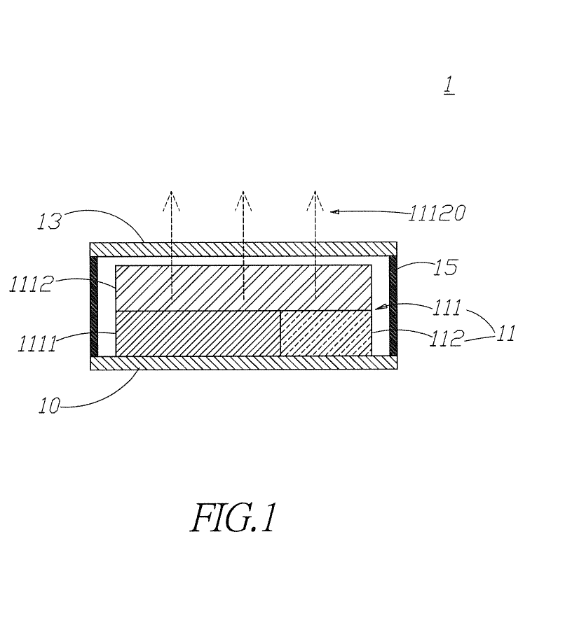

Refer to FIG. 1, a touch panel 1 of the present invention includes a substrate 10, a display module 111, a touch sensing module 112 and a cover plate 13. The touch sensor module 112 is optical-type and is directly mounted in the display module 111. In this embodiment, the display module 111 is an organic electroluminescent display module including a thin film transistor 1111 and an organic electroluminescent element 1112. The touch sensor module 112 is disposed on one side of the thin film transistor 1111 while the organic electroluminescent element 1112 is arranged over both the thin film transistor 1111 and the touch sensor module 112. The display module 111 and the touch sensor module 112 are connected to form a touch display module 11.

The substrate 10 and the cover plate 13 are respectively set over and under the touch display module 11. That means the substrate 10 is disposed under the thin film transistor 1111 of the touch display module 11 while the touch sensor module 112 is arranged over the substrate 10. The touch sensor module 112 is formed together with the thin film transistor 1111 during manufacturing processes. Moreover, the cover plate 13 is covered over the organic electroluminescent element 1112 of the display module 111 and is corresponding to the substrate 10. In other words, the touch display module 11 composed of the display module 111 and the touch sensor module 112 connected to each other is clipped between the substrate 10 and the cover plate 13 so as to form the touch panel 1 in this embodiment. Finally, a sealing adhesive 15 is set between the substrate 10 and the cover plate 13 so as to integrate the substrate 10, the touch display module 11 having the display module 111 and the touch sensor module 112, and the cover plate 13 into one piece. Compared with conventional touch panel, the present invention only includes the touch display module 11 clipped between the substrate 10 and the cover plate 13. Thus the thickness of the touch panel 1 of the present invention is smaller than the thickness of the conventional touch panel and this meets customers' requirements.

While being applied with a voltage, the organic electroluminescent element 1112 in an excited state generates a light source 11120 that moves toward the cover plate 13. Thus a surface of the cover plate 13 is a light emitting surface and at the same time is also a touch control surface for users to perform operations such as press and touch. In this embodiment, the cover plate is made from matrix whose Mohs hardness is greater than 8 such as sapphire or spinel. Thus the cover plate 13 has better surface hardness and there is no need to coat the surface or have surface treatment of the cover plate 13 such as anti-smudge treatment, anti finger treatment. The cover plate 13 is durable, not easily cracked or broken after long-term or multiple times of pressing and touching. There is no scratch, dirt or damage caused by friction on the surface of the cover plate 13 due to better surface hardness of the cover plate 13. Moreover, the manufacturing cost of the touch panel is reduced without additional surface treatment of the cover plate 13. Similarly, the substrate 10 of this embodiment can also be made from matrix with the Mohs hardness greater than 8.

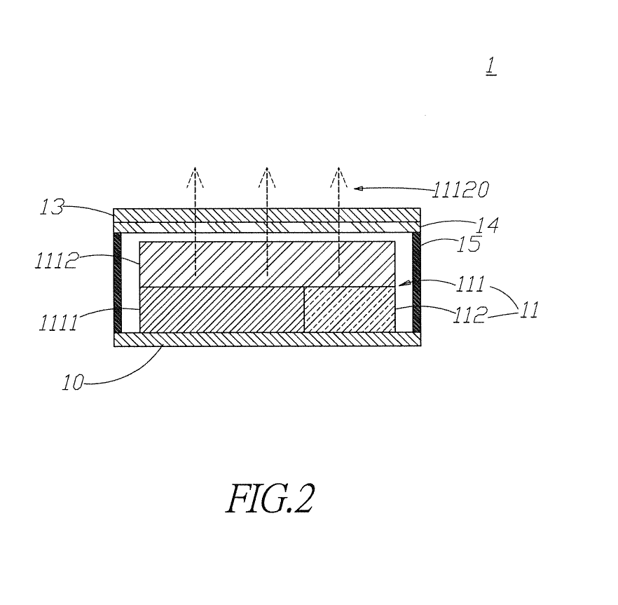

Refer to FIG. 2, another embodiment is revealed. As shown in figure, a cover plate 13 of this embodiment is made from sapphire or spinel. The refractive index of these two materials is similar to that of the materials for the organic electroluminescent element 1112, about 1.7 Thus total internal reflection will not occur easily when the light source 11120 emitted from the organic electroluminescent element 1112 is projected to the cover plate 13 and the light source 11120 passes through the cover plate 13 so that light output efficiency of the touch panel 1 is improved significantly.

Due to similar refractive index of the materials for the cover plate 13 and the organic electroluminescent element 1112, the surface of the cover plate 13 can have special optical design. For example, the surface of the cover plate 13 of this embodiment close to the touch display module 11 is coated with at least one optical thin film 14 such as brightness enhancement film (BEF). In this embodiment, the refractive index of the optical thin film 14 is smaller than that of the cover plate 13, about 1.52. The materials for the optical thin film include metal oxides, metal fluorides, etc. The thickness of the optical thin film 14 is ranging from 200 nm to 1200 nm while 300 nm to 700 nm is preferred. The combination of high refractive index/low refractive index results in Bragg resonance and total internal reflection will not occur. The surface reflection of the cover plate 13 is reduced effectively. Thus the light output efficiency and the display contrast of the touch panel 1 are improved significantly.

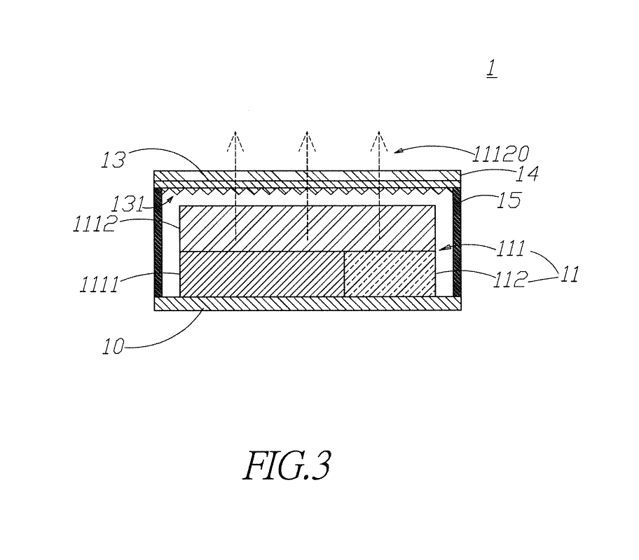

Refer to FIG. 3, a further embodiment is disclosed. As shown in the figure, a surface of the cover plate 13 close to the touch display module 11 in this embodiment forms a 3-dimensional (3D) pattern layer 131. The 3D pattern layer 131 is for reducing total internal reflection of internal light source of the touch panel 1 and increasing light output efficiency of the touch panel 1. In this embodiment, at least one optical thin film 14 such as anti-reflection (AR) film is coated on a surface of the cover plate 13 with the 3D pattern layer 131 and is corresponding to the touch display module 11, respectively at different side of the cover plate 13. The optical thin film 14 reduces total internal reflection and surface reflection of the cover plate 13 so as to increase the light output efficiency and the display contrast of the touch panel 1 dramatically.

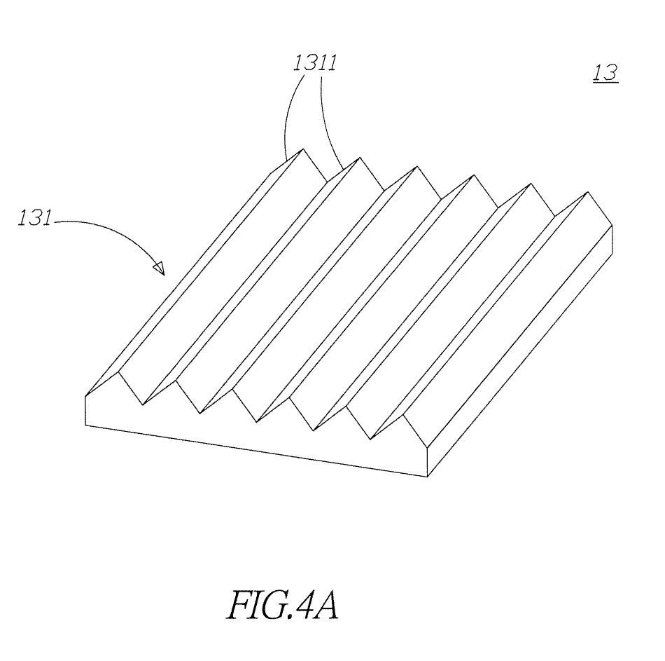

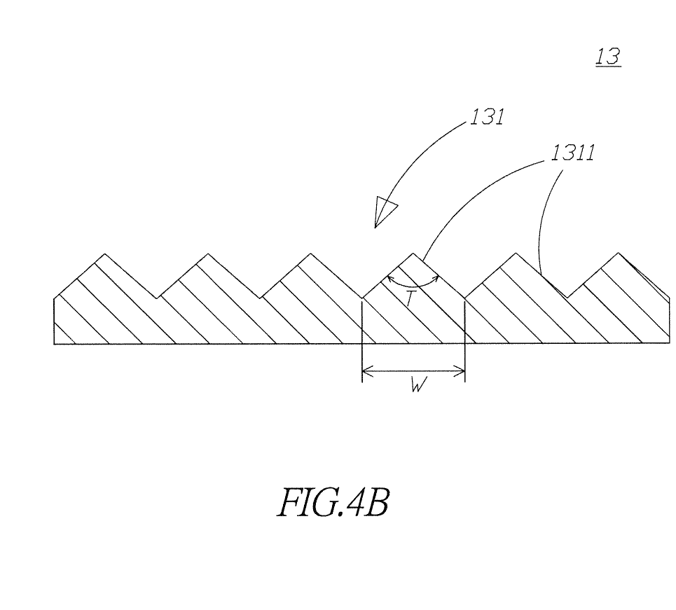

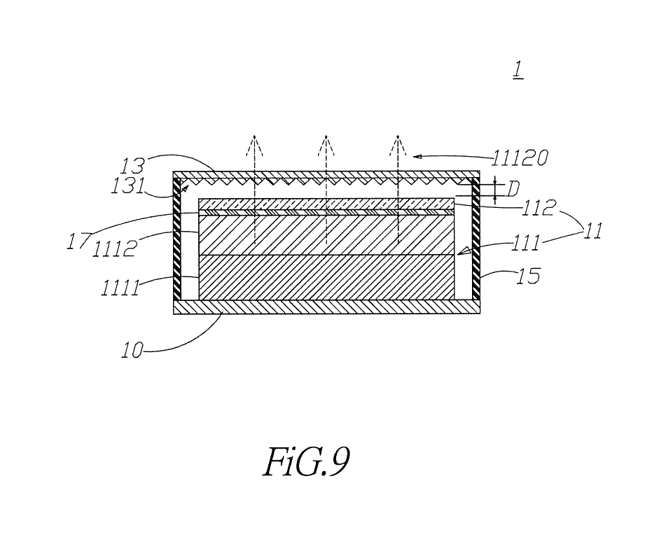

Refer to FIG. 4A and FIG. 4B, the 3D pattern layer 131 is formed by a plurality of 3D figures. In this embodiment, each 3D figure is a strip such as a strip grating 1311 arranged in a linear array. A cross section of each strip grating 1311 is a triangle. The bottom width W of the cross section of the strip grating 1311 is ranging from 300 nm to 20 μm while the optimal width is between 600 nm-5 μm. A vertex angle T of the cross section of the strip grating 1311 is ranging from 100 degrees to 180 degrees while 110 degrees to 150 degrees is preferred. As shown in FIG. 9, there is a distance D set between a vertex of each 3D figure (strip grating 1311) of the 3D pattern layer 131 of the cover plate 13 and the touch display module 11. The distance D is ranging from 0 mm to 1 mm. The cover plate 13 reduces the total internal reflection and further improves the light output efficiency of the touch panel 1.

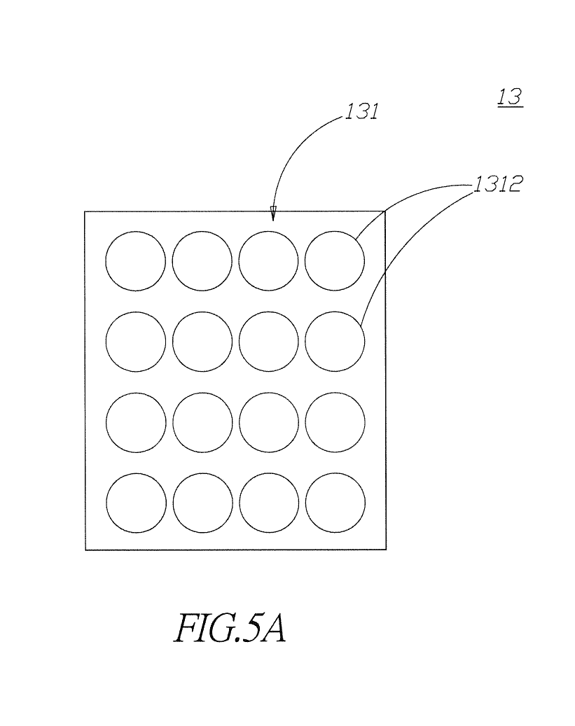

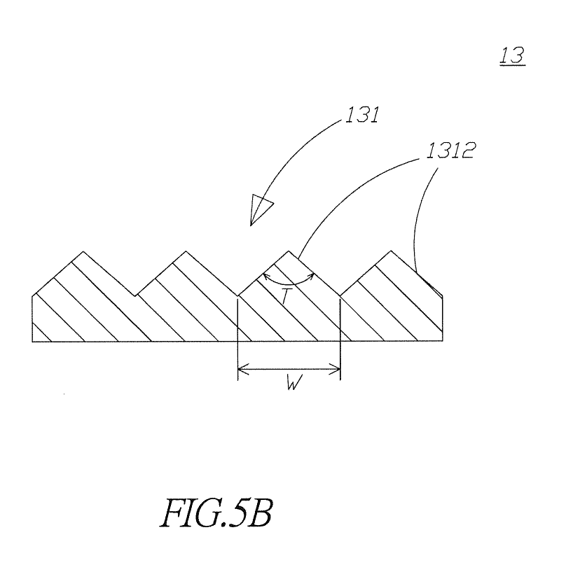

Refer to FIG. 5A and FIG. 5B, a top view and a cross sectional view of a further embodiment according to the present invention are revealed. As shown in the figures, a 3D pattern layer 131 of this embodiment is formed by a plurality of cones such as point-like microprism lenses 1312 arranged into a matrix/array. A cross section of each point-like microprism lens 1312 is a triangle. The bottom width W of the cross section of the point-like microprism lens 1312 is ranging from 300 nm to 20 μm while the optimal width is between 600 nm-5 μm. A vertex angle T of the cross section of the point-like microprism lens 1312 is ranging from 100 degrees to 180 degrees while 110 degrees to 150 degrees is preferred.

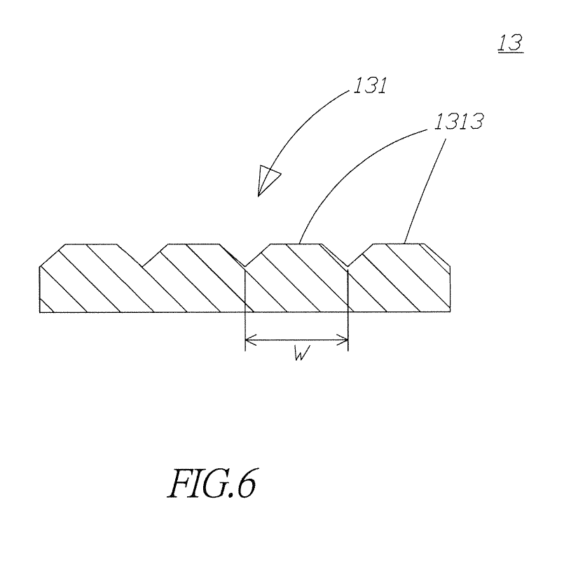

Refer to FIG. 6, a cross sectional view of a further embodiment according to the present invention is revealed. A further 3D pattern layer 131 is provided in this embodiment. The 3D pattern layer 131 of this embodiment is formed by a plurality of conics arranged into a matrix/array. The difference between this embodiment and the above embodiment is in that the cone of this embodiment is a point-like microprism lens 1313 whose cross section is a trapezoid. The bottom width W of the point-like microprism lens 1313 is ranging from 300 nm to 20 μm while the preferred bottom width W is between 600 nm and 5 μm.

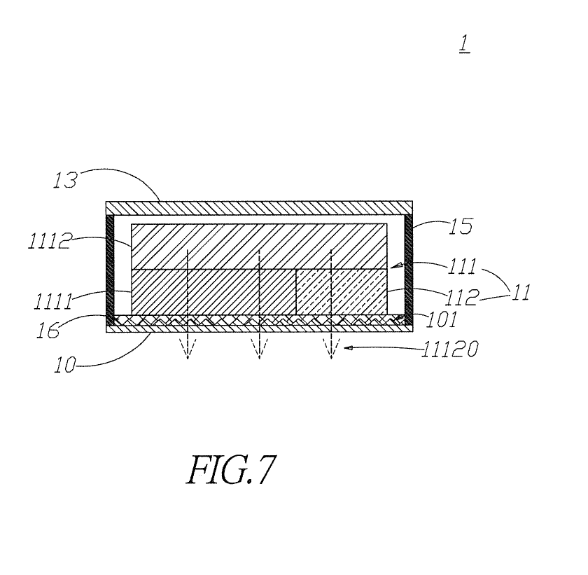

Refer to FIG. 7, a further embodiment is revealed. As shown in the figure, the light source 11120 generated from the organic electroluminescent element 1112 moves toward the cover plate 13 so that the surface of the cover plate 13 becomes a light emitting surface and a touch control surface. In this embodiment, the light source 11120 generated from the organic electroluminescent element 1112 can also move toward the substrate 10 so that the surface of the substrate 10 also becomes a light emitting surface and a touch control surface. In this embodiment, the substrate 10 and cover plate 13 of the above embodiments are made from the same materials. A surface of the substrate 10 facing the touch display module 11 is patterned so as to form a 3D pattern layer 101. Before the touch display module 11 being disposed on the substrate 10, a flat layer 16 is arranged at the substrate 10 over which the touch display module 11 is disposed.

When the light source 11120 from the organic electroluminescent element 1112 moves toward the substrate 10, the 3D pattern layer 101 of the substrate 10 reduces total internal reflection caused by internal light source of the touch panel 1 and increases light transmittance of the touch panel 1. Thus the light output efficiency of the touch panel 1 is improved significantly. The cover plate 13 of this embodiment is made from tempered glass substrate used in conventional touch panels. The matrix with the Mohs hardness greater than 8 is preferred. Thus the surface of the cover plate 13 is with good hardness and there is no need to have following anti-smudge treatment and surface coating. Therefore the manufacturing cost of the touch panel 1 is down.

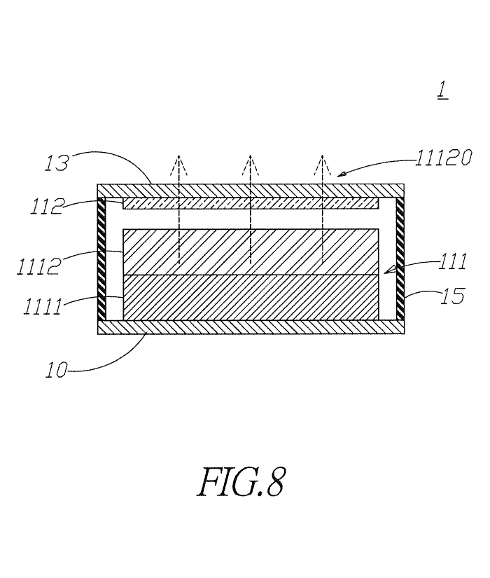

Refer to FIG. 8, a further embodiment is disclosed. The touch panel 1 of this embodiment is different from the above embodiments in that a touch sensor module 112 of this embodiment is capacitive, not mounted in the display module 111. The touch sensor module 112 is arranged between the display module 111 and the cover plate 13. In this embodiment, the touch sensor module 112 is disposed on one surface of the cover plate 13 that faces the display module 111. When the organic electroluminescent element 1112 is applied with a voltage, it generates a light source 11120 that moves toward the cover plate 13. Thus the surface of the cover plate 13 can be a light emitting surface and also a touch control surface to be pressed and touched by users. In this embodiment, the cover plate 13 is made from matrix whose Mohs hardness is greater than 8 such as sapphire or spinel. With sufficient hardness, the surface of the cover plate 13 is not necessary to have surface coating and anti-smudge treatment. Thus the cover plate 13 of this embodiment is durable. After long term use or multiple times of pressing and touching, it will not have cracks, breakage, scratches or stains. While in contact with other objects, the surface of the cover plate 13 will not have damages caused by friction therebetween.

Refer to FIG. 9, a further embodiment is disclosed. As shown in figure, a touch sensor module 112 is disposed above and integrated with a display module 111 to form a touch display module 11. A protection layer 17 is arranged between the touch sensor module 112 and an organic electroluminescent element 1112 of the display module 111 to prevent electrical interference between the touch sensor module 112 and the organic electroluminescent element 1112. In this embodiment, a surface of a cover plate 13 and a surface of the touch sensor module 112 are respectively set with a 3D pattern layer 131 so as to reduce total internal reflection of internal light source of the touch panel 1 and increase light output efficiency of the touch panel 1. The 3D pattern layer 131 is formed by a plurality of 3D figures, as shown from FIG. 4A to FIG. 6. There is a distance D between a vertex of the 3D pattern layer 131 and the touch sensor module 112 as the distance D between the vertex of the 3D pattern layer 131 and the touch display module 11 mentioned above. Moreover, the surface of the cover plate 13 is coated with at least one optical thin film as the above embodiment.

In summary, the touch panel of the present invention is composed of the touch display module clipped between the substrate and the cover plate so that the thickness of the touch panel is reduced significantly. Moreover, the cover plate or the substrate is made from matrix having Mohs hardness greater than 8. Thus the surface of the cover plate or of the substrate is with higher surface hardness is not necessary to have coating or anti-smudge treatment. The manufacturing cost of the touch panel is dramatically reduced and this meets customers' requirements. Furthermore, an inner surface of the cover plate/or the substrate is patterned to form a 3D pattern layer thereon for reducing total internal reflection of an internal light source of the touch panel and further improving light output efficiency of the touch panel. Finally, the refractive index of the materials for the cover plate/or the substrate is similar to that of the materials for the organic electroluminescent element and the outer surface of the cover plate/or the substrate is coated with at least one optical thin film whose refractive index is smaller than the refractive index of the cover plate/or the substrate. Thus the combination of high refractive index and the low refractive index results in Bragg resonance and the light output efficiency of the touch panel 1 is further improved.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents,

What is claimed is:

1. A touch panel comprising:
a substrate;
a touch display module arranged at the substrate; and
a cover plate covering the touch display module;
wherein only a Mohs hardness of the substrate or a Mohs hardness of the cover plate is greater than 8, or a Mohs hardness of both the substrate and the cover plate is greater than 8.

2. The device as claimed in claim 1, wherein material for the cover plate is sapphire or spinel.

3. The device as claimed in claim 1, wherein the touch display module includes
a display module having
a thin film transistor arranged over the substrate; and
an organic electroluminescent element disposed on the thin film transistor; and
a touch sensor module set on the substrate and located at one side of the thin film transistor; the organic electroluminescent element is over the touch display module.

4. The device as claimed in claim 1, wherein the touch display module includes
a display module having
a thin film transistor arranged over the substrate; and
an organic electroluminescent element disposed on the thin film transistor; and
a touch sensor module set on the organic electroluminescent element of the display module.

5. The device as claimed in claim 1, wherein the cover plate includes a 3-dimensional (3D) pattern layer disposed on a surface thereof and located between the cover plate and the touch display module; the 3D pattern layer includes a plurality of 3D figures, each of which is a strip or a cone, arranged in a matrix; there is a distance between a vertex of the 3D figure and the touch display module and the distance is ranging from 0 mm to 1 mm; a cross section of the 3D figure is a triangle or a trapezoid and a bottom width of the cross section of the 3D figure is ranging from 300 nm to 20 μm.

6. The device as claimed in claim 5, wherein the cross section of the 3D figure is a triangle and a vertex angle of the triangle is ranging from 100 degrees to 180 degrees.

7. The device as claimed in claim 1, wherein the cover plate further includes at least one optical thin film arranged at one surface of the cover plate and a refractive index of the optical thin film is smaller than a refractive index of the cover plate, smaller than 1.52; a thickness of the optical thin film is ranging from 200 nm to 1200 nm and material for the optical thin film is metal oxide or metal fluoride.

8. The device as claimed in claim 1, wherein the substrate further includes a includes a 3-dimensional (3D) pattern layer disposed on a surface thereof and located between the substrate and the touch display module; the 3D pattern layer includes a plurality of 3D figures, each of which is a strip or a cone, arranged in a matrix; there is a distance between a vertex of the 3D figure and the touch display module and the distance is ranging from 0 mm to 1 mm; a cross section of the 3D figure is a triangle or a trapezoid and a bottom width of the cross section of the 3D figure is ranging from 300 nm to 20 μm.

9. The device as claimed in claim 8, wherein the cross section of the 3D figure is a triangle and a vertex angle of the triangle is ranging from 100 degrees to 180 degrees.

10. A touch panel comprising:
a substrate;
a display module disposed on the substrate;
a cover plate covering the display module; and
a touch sensor module arranged at the cover plate and located between the cover plate and the display module;
wherein a Mohs hardness of the cover plate is greater than 8.

11. The device as claimed in claim 10, wherein material for the cover plate is sapphire or spinel.

12. The device as claimed in claim 10, wherein the cover plate on the touch sensor module further includes: at least one optical thin film arranged at one surface of the cover plate and a refractive index of the optical thin film is smaller than a refractive index of the cover plate, smaller than 1.52; a thickness of the optical thin film is ranging from 200 nm to 1200 nm and material for the optical thin film is metal oxide or metal fluoride.
